(19) United States
(12) Patent Application Publication
(10) Pub. No.: US 2009/0265840 A1
(43) Pub. Date: Oct. 29, 2009

(54) HELMET CUSTOMIZABLE BY VARIATION OF INNER VOLUME

(75) Inventors: Herve FAVRE-FELIX, Villaz (FR); Gilles RENAUD-GOUD, Gruffy (FR)

Correspondence Address: GREENBLUM & BERNSTEIN, P.L.C., 1950 ROLAND CLARKE PLACE, RESTON, VA, 20191, US

(73) Assignee: SALOMON S.A.S., Metz-Tessy (FR)

(21) Appl. No.: 12/428,993

(22) Filed: Apr. 23, 2009

(30) Foreign Application Priority Data
Apr. 24, 2008 (FR) 08.02303

(51) Int. Cl. A42B 1/22; H05B 6/00; B28B 21/98; B29C 43/18

(52) U.S. Cl. 2/417; 264/493; 425/2; 264/319

(57) ABSTRACT

A helmet including a structure for protecting the user's head, a comfort structure positioned between the user's head and the protective structure, and a customization structure arranged between the protective structure and the comfort structure, the customization structure making it possible to vary the inner volume of the helmet depending upon the user's morphology. The customization structure includes a thermoplastic envelope made of a polymeric material of the polycarbonate, polyurethane, or polypropylene type, to which an additive of the caprolactone type is added in order to lower the softening temperature thereof. The proportion of the additive in the material of the envelope ranges between 30% and 90% or between 50% and 80%. A free space can be provided between the envelope and the protective structure for the head, such free space remaining empty and having a depth ranging between 2.0 mm and 5.0 mm, such as approximately 3.0 mm.

### CROSS-REFERENCE TO RELATED APPLICATION

The instant application is based upon the French priority Patent Application No. 08.02303, filed Apr. 24, 2008, the disclosure of which is hereby incorporated by reference thereto, and the priority of which is hereby claimed under 35 U.S.C. §119.

### BACKGROUND OF THE INVENTION

1. Field of the Invention

The invention relates to a helmet that includes an arrangement to protect the user's head as well as to provide comfort to the head. In particular, but not exclusively, the invention relates to a helmet intended for the practice of various sports, such as, but not limited to, skiing, snowboarding, hockey, football, soccer, and roller skating. It also relates to a heating arrangement to adapt the helmet to the user's morphology.

2. Background Information

In a known fashion, a helmet includes a structural arrangement for protecting the head, which provides protection to the skull from impacts occasioned by the user falling, or impacts occasioned by an object directed toward the user's head. Such protective arrangements typically are composed of a shell and a shock-absorbing cap. The shell can be rigid, being made, for example, by injection molding a thermoplastic material such as ABS (Acrylonitrile Butadiene Styrene), or it simply can be an outer skin having no inherent rigidity, but acquiring some rigidity from being connected to the shock-absorbing cap. For example, the skin can be made by shaping a sheet of PVC (Polyvinyl chloride) or PC (Polycarbonate).

Typically, the shock-absorbing cap is made of an expanded material such as EPS (expanded polystyrene) or polystyrene.

To guarantee good comfort for the user, a helmet can be equipped with comfort elements, which can be in the form of an inner cap made, for example, of foam covered with fabric.

Numerous devices are known from the prior art, which make it possible to adapt the inner volume of the helmet to the user's head.

For example, the patent document U.S. Pat. No. 6,647,556 proposes to adapt the volume by sliding the various portions constituting the helmet with respect to one another. Such a device is difficult to adjust and makes the helmet relatively heavy for the user to wear.

Another example is provided by the patent document FR 2 888 729, by which the inner volume of the helmet is to be modified by inflating or deflating a bladder using a manual pump. Such a device is expensive, bulky, and the adaptation which it offers is localized to certain areas. In addition, too much pressure in the bladder can cause discomfort for the user.

Indeed, and true for all of the volume adaptation devices, it is absolutely necessary to prevent the helmet from locally exerting excess pressure on the user's head.

### SUMMARY OF THE INVENTION

In view of the disadvantages of the prior art, there exists a need to provide a helmet, in particular for sporting activities, that includes an arrangement to customize its inner volume to the wearer, which arrangement is easy to use, compact, inexpensive, and which adapts to any skull shapes.

To this end, the invention provides a helmet including an arrangement that includes various benefits, including a structure that protects the user's head, a structure that provides comfort between the user's head and the protective structure, and a customization structure arranged between the protective and the comfort structures, the customization structure making it possible to vary the inner volume of the helmet depending upon the user's morphology.

Advantageously, the customization structure includes a thermoplastic envelope, which is heat thermoformable.

Advantageously, the envelope is made of a polymeric material such as polycarbonate, polyurethane, or polypropylene, to which an additive is added in order to lower the softening temperature thereof.

Advantageously, the proportion of the additive in the material of the envelope can range between 30% and 90%, and, in another embodiment, between 50% and 80%.

In a specific embodiment, the additive is caprolactone.

According to a feature of a particular embodiment of the invention, the envelope is perforated, i.e., includes openings.

In one embodiment of the invention, a free space is provided between the envelope and the head protective structure, this free space remaining empty and being capable of having a depth of approximately 3.0 mm.

In another embodiment of the invention, the space provided between the head protective structure and the envelope is filled with a foam having a very low density, including lower than 20 kg/m³.

In another embodiment of the invention, studs projecting from the shock-absorbing cap extend through the free space and come in contact with the envelope.

The head protective structure can be constituted of a shell and a shock absorbing cap.

The invention also encompasses a method for implementing a customization of the inner volume of a helmet in order to adapt it to the user's morphology, the helmet including a structure to protect the user's head, the protective structure including an outer surface and an inner surface; a comfort arrangement positioned between the user's head and the inner surface, and a customization structure arranged between the protective structure and the comfort structure, such method including the following:
defining the inner zones of the helmet for which the user's morphology requires an increase in volume;
heating the helmet to a temperature below 80° C.;
inserting the user's head or a dummy head in the heated helmet, the dummy head being adaptable and modifiable to more closely follow the shape of the user's head.

### BRIEF DESCRIPTION OF DRAWINGS

The invention can be better understood upon reading the description which follows, with reference to the annexed drawings, and in which:

FIG. 1 is a cross-sectional view of the helmet according to a first embodiment of the invention;

FIG. 2 is a partial cross-sectional view of a helmet according to a third embodiment;

FIG. 3 is a perspective view of the envelope according to the first embodiment for the invention;

FIG. 4 is a perspective view of an envelope according to a second embodiment of the invention;

FIG. 5 is a view showing the helmet heating step;

FIG. 6 is a view showing the envelope shaping step according to the invention;

FIG. 7 is a perspective view of a dummy head used in the envelope shaping step and/or in the heating step according to the invention.

### DETAILED DESCRIPTION OF THE INVENTION

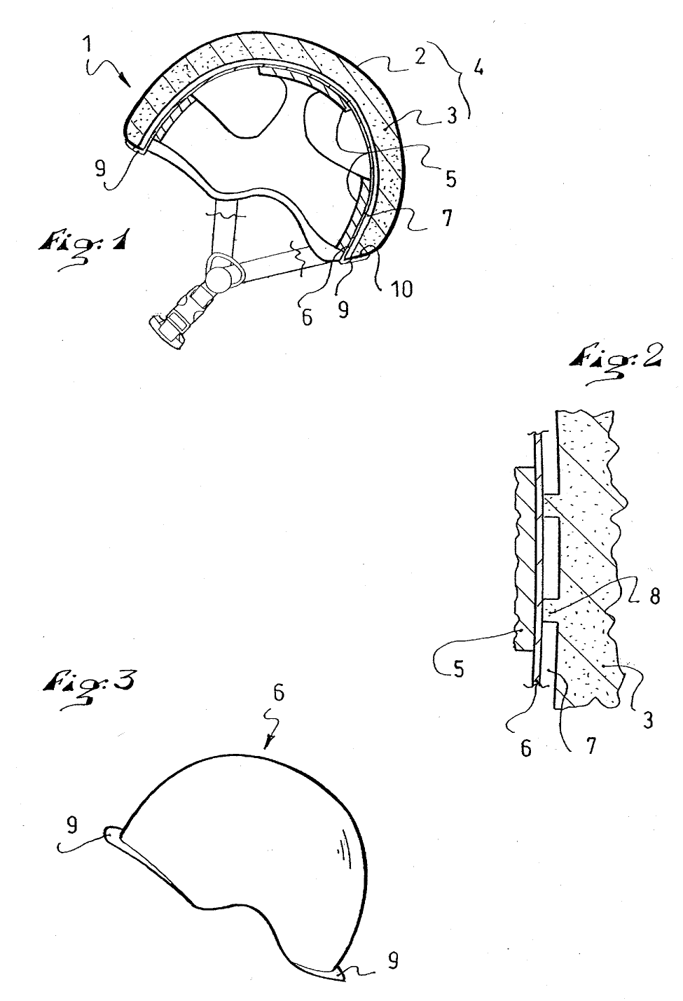

FIG. 1 shows a cross-sectional view of a helmet 1 according to the invention. It includes a protective structure 4 for protecting the user's head. This protective structure includes a shell 2 and a shock-absorbing cap 3. In the illustrated example, the shell 2, made by the shaping of a sheet of polycarbonate, is directly affixed to the shock-absorbing cap 3, made of EPS. The shell 2 and cap 3 are affixed to one another in an EPS expansion mold. This is referred to as In-Mold Technology.

This particular manner of constructing the protective structure is only one among others, without it being limiting to the scope of the invention. Indeed, the protective structure can be made by adhesively bonding, snap fastening, or clip fastening a rigid shell and a shock-absorbing cap to one another.

In order to improve the user's comfort, the helmet 1 is equipped with a comfort structure, here in the form of the inner cap 5. In a manner known per se, such inner cap can be made using foam pad(s) which can be associated with fabrics.

The materials used for the inner cap can include foams having a density between 15 kg/m³ and 40 kg/m³. In a particular embodiment, the density can be between 20 kg/m³ and 30 kg/m³.

According to the invention, the helmet 1 includes a customization structure, which makes it possible to adapt the inner volume of the helmet to the shape of the user's skull. In the illustrated embodiment, the customization structure includes an envelope 6 positioned between the protective structure 4 and the comfort structure 5.

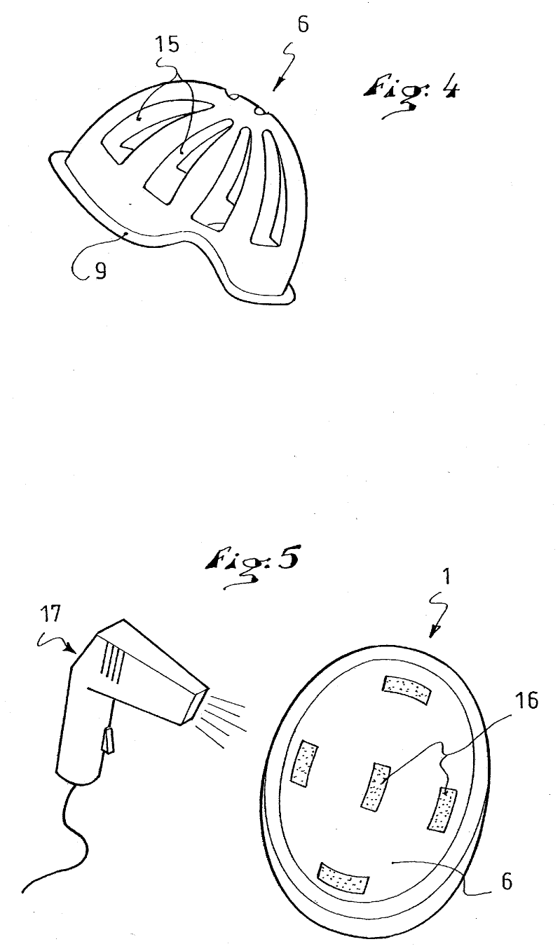

FIG. 3 illustrates the envelope 6 of the helmet 1 of FIG. 1 prior to being positioned within the helmet. As can be seen, the envelope assumes the general shape of the helmet, i.e., the shape of a skull, and it can include two bearing surfaces 9, one being positioned at the front, and the other at the rear. The bearing surfaces 9 are used for fixing the envelope 6 to the protective structure 4.

In the first embodiment the envelope 6 is a continuous structure, i.e., a structure that covers the skull entirely without perforations or openings through its thickness. However, the thickness of the envelope can include zones in which its thickness varies so as to be thinner or thicker. Thus, there are zones of the envelope that are more or less sensitive to deformation.

FIG. 4 illustrates an envelope 6 according to a second embodiment of the invention. Unlike the first embodiment, the envelope here is not continuous and includes a plurality of openings 15 through the thickness of the envelope. The openings 15 enable the envelope to deform more easily in order to conform to the shape of the user's skull. Because of the openings, the helmet is also lighter and better ventilated. In addition, the openings allow for a better control of the helmet adaptability.

The openings 15 can be judiciously positioned in the areas where contact with the helmet is the least supported by the human skull.

The envelope 6 shown in FIG. 4 has a bearing surface 9 extending along its entire circumference, or lower periphery, to enable a more efficient fixing to the cap.

According to the invention, the envelope 6 shown in FIGS. 2 and 3 is made of a thermoplastic compound whose softening point is low, such as lower than 80° C.

The thermoplastic compound used to manufacture the envelope is a polymeric compound of the polycarbonate, polyurethane, or polypropylene type, to which an additive is added. All of these polymers have, at room temperature, a behavior that is compatible with their use in a helmet.

When used alone, these polymeric compounds have relatively high softening points. The softening point is defined as being the temperature at which the matter is malleable. The temperature of the softening point is lower by a few tens of degrees than the transformation temperature. The following are some examples of transformation temperature: polycarbonate (285° C.-300° C.), polyurethane (210° C.-230° C.), polypropylene (220° C.-230° C.).

The additive is selected such that it causes the softening point of the compound to drop substantially.

Good results can be achieved with an additive known by the name caprolactone or caprolactane, and in particular with a product known by the trade name CAPA 6500. This is a linear polyester with high molecular weight derived from caprolactone monomer. Other caprolactone-base polymers are also suitable.

This additive has a melting point of 60° C. to 80° C. in one zone. Mixed with the base substance in a proportion ranging between 30% and 90%, or between 50% and 80% in a particular embodiment, it has been found that it lowers the softening temperature of the base substance, in particular of the polymeric compound, without significantly affecting the mechanical properties of the envelope, in particular its rigidity, or its aesthetic appearance under the normal conditions of use of a helmet according to the invention.

Other additives can also be used, provided that they are miscible with the base substance during their injection, that they have a low melting point, such as lower than 100° C. according to a particular embodiment of the invention, and that their presence in the base substance lowers its softening temperature significantly.

As shown in FIG. 1, the envelope is fixed to the protective structure 4 via fixing structure 10 connecting the bearing surfaces 9 to the circumference of the cap. The fixing structure 10 can be one of any known types. For example, it can be an adhesive, a rivet, or a fastener, etc.

Advantageously, the positioning of the envelope in the cap 3 is carried out such that a free space 7 is maintained between the surface of the envelope and the inner surface of the cap 3.

The free space 7 enables the envelope to become deformed in order to increase locally the inner volume of the helmet. A free space 7 measuring between 1.0 mm and 5.0 mm, i.e., in a direction toward or away from the head, is provided. In a particular embodiment, the free space measures 3.0 mm, or approximately 3.0 mm.

In the first embodiment, the free space 7 is left empty. In a third embodiment of the invention, the otherwise free space 7 is filled by a low density foam, for example with density lower than 20 kg/m³. The presence of the low density foam improves the strength of the envelope without hindering the deformation thereof during the process of customizing the helmet.

According to a particular embodiment, various zones of the surface of the space 7 can be filled with foams having slightly different densities. Thus, in the zones where support is necessary, a foam that is denser and offers more support could be used.

A third embodiment is shown in FIG. 2. Only a detail is shown here, the remainder being identical to the first embodiment. As can be seen in FIG. 2, studs 8 projecting from the shock-absorbing cap 3 extend through the free space 7 and are used as a support zone for the envelope 6. Such studs can be unitary with, or not unitary with, the cap 3.

The studs are distributed on the inner surface of the cap 3 in areas where little or no variation in the skull shape occurs in the user population.

An alternative of this embodiment, not shown, involves having removable studs 8 that can be displaced on demand on the inner surface of the cap 3.

The helmet also includes a comfort structure comprised of an inner cap 5 attached inside the envelope 6. The inner cap 5 is removably attached by means of self-gripping bands 16, such as hook-and-loop fasteners (such as marketed under the name VELCRO®).

According to the invention, the method for customizing the inner volume of the helmet to adapt it to the user's morphology is described immediately below.

The user selects an appropriately sized helmet, fits it upon his/her head and then takes note of the zones of the inner surface thereof which negatively affect comfort, such as the zones where too much pressure is exerted on the skull.

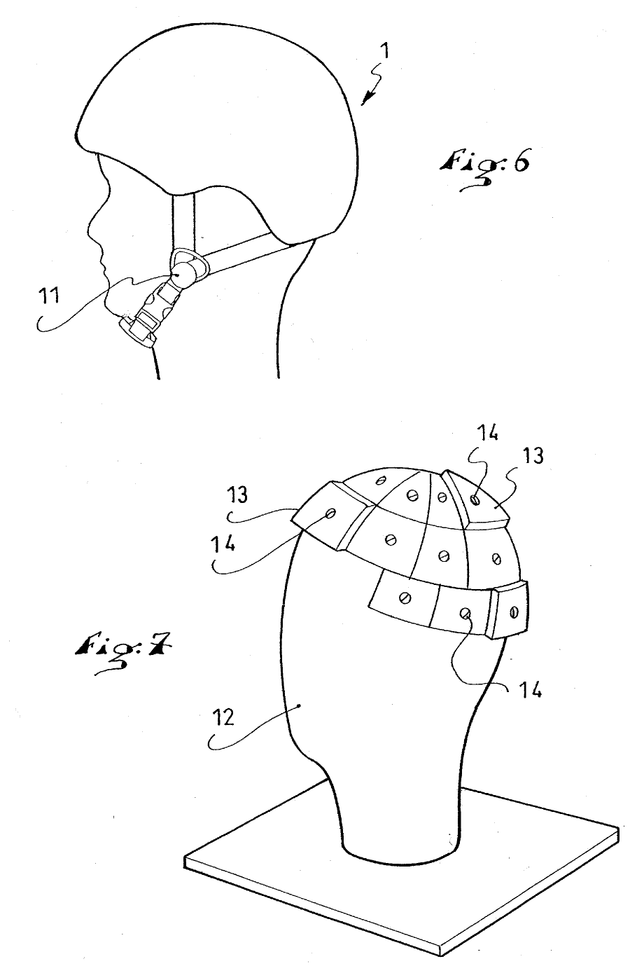

Once the zones requiring an increase in volume have been identified, the inner cap is removed (when it is possible), and then the helmet is heated to a temperature ranging between 50° C. and 80° C. FIG. 5 illustrates the heating of the helmet 1. The helmet is shown in a bottom view, with the inner cap 5 having been removed. Only the self-gripping bands 16 used for attaching the inner cap are visible. The heating apparatus 17 includes a hot air blowing device having a motor-operated impeller, such as that known under the registered trademark LEISTER®.

The heating apparatus can also be selected from among other known devices, such as an electric oven or a device with an infra-red lamp, the latter offering the advantage of heating speed.

Finally, the inner cap (if it is removed) is repositioned, and the helmet is then fitted again on the head in the position of use, i.e., with the chin-strap 11 fastened as is shown in FIG. 6.

In an alternative method for customizing the volume of the helmet, a dummy head 12 is used to carry out the deformation of the envelope 6 once the envelope is heated.

An example of a dummy head 12, according to the invention, is shown in FIG. 7. The dummy head 12 has an outer surface reproducing the shape of a human skull, adjustable elements 13 which make it possible to modify the shape of the outer surface.

Each adjustable element 13 is a tile which can be moved radially (i.e., toward or away from the surface of the head) by means of an adjusting mechanism, such as a screw 14, for example.

In an alternative customization method, the dummy head is used as soon as the user has identified the zones of the inside of the helmet for which he/she wishes an increase in volume.

The user can then adjust the dummy head accordingly and position the heated helmet thereon so that the defined zones can be deformed by the adjustable elements 13.

In another version, the dummy head includes the heating device. For example, a hot-air blower or infra-red lamp could be positioned within the dummy head. In such a version, after having defined the zones for which he/she desires an increase in volume, the user positions the helmet on the dummy head, which is equipped with heating device that brings the envelope 6 to a temperature close to its softening point. Those of the adjustable elements 13 that are adjusted in order to project from the outer surface of the dummy head then exert pressure on the envelope in order to deform it.

The invention is not limited to the specific embodiments described above, and includes all of the technical equivalents that fall within the scope of the claims which follow hereinafter.

Further, the invention illustratively disclosed herein can be suitably practiced in the absence of any element which is not specifically disclosed herein.

1. A helmet comprising:
a protective structure to protect a user's head;
a comfort structure positioned between the protective structure and the user's head;
a customization structure arranged between the protective structure and the comfort structure, said customization structure comprising a thermoplastic envelope, said envelope being a heat-thermoformable polymeric material;
said heat-thermoformable polymeric material comprising a material selected from the group consisting of a polycarbonate, a polyurethane, and a polypropylene; and
an additive for lowering a softening temperature of said heat-thermoformable polymeric material;
said additive being caprolactone.

2. A helmet according to claim 1, wherein:
said additive forming a proportion of the thermoplastic envelope within a range of between 30% and 90%.

3. A helmet according to claim 1, wherein:
said additive forming a proportion of the thermoplastic envelope within a range of between 50% and 80%.

4. A helmet according to claim 1, wherein:
a free space is provided between the envelope and the protective structure, said space having a depth between 2.0 mm and 5.0 mm.

5. A helmet according to claim 1, wherein:
a free space is provided between the envelope and the protective structure, said space having a depth of approximately 3.0 mm.

6. A helmet according to claim 1, wherein:
a space is provided between the envelope and the protective structure, said space having a depth between 2.0 mm and 5.0 mm;
a low-density foam is provided in the space provided between the envelope and the protective structure.

7. A helmet according to claim 1, wherein:
the low-density foam has a density less than 20 kg/m³.

8. A helmet according to claim 4, wherein:
studs projecting from the shock absorbing cap and extend through the free space and come in contact with the envelope.

9. A method for customizing an inner volume of a helmet to adapt the helmet to a shape of a user's head, said helmet including (a) a head-protective structure comprising an outer surface and an inner surface; (b) a head-comfort structure positioned between the inner surface and the user's head; and (c) a customization structure positioned between the head-protective structure and the head-comfort structure, said customization structure comprising a thermoplastic envelope, said method comprising:
defining inner zones of the helmet for which a shape of the user's head requires an increase in volume;
heating the envelope to a temperature less than 80° C.;
inserting a dummy head in the heated envelope, said dummy head being adaptable and modifiable to follow more closely the shape of the user's head.

10. A method for customizing the inner volume of a helmet according to claim 9, wherein:
the heating is carried out with a heating device comprising a member of a group consisting of the following: a hot air blower device; an oven device; and a device having an infra-red lamp.

11. A method for customizing the inner volume of a helmet according to claim 9, further comprising:
removing the head-comfort structure is before said heating; and
repositioning the head-comfort structure before said inserting the dummy head.

12. A method for customizing the inner volume of a helmet according to claim 9, wherein:
the heating means is constituted by a heating device integrated into the dummy head.

13. A dummy head comprising:
an outer surface having a shape of a human skull;
the dummy head being structured and arranged to be used in a method for customizing an inner volume of a helmet to adapt the helmet to a shape of a user's skull, the helmet including (a) a head-protective structure comprising an outer surface and an inner surface; (b) a head-comfort structure positioned between the inner surface and the user's skull; and (c) a customization structure positioned between the head-protective structure and the head-comfort structure, said customization structure comprising a thermoplastic envelope, the method comprising:
(i) defining inner zones of the helmet for which the shape of the user's skull requires an increase in volume;
(ii) heating the envelope to a temperature less than 80° C.;
(iii) inserting the dummy head in the heated envelope;
the dummy head comprising a plurality of adjustable elements structured and arranged to be repositioned to follow more closely the shape of the outer surface of the user's skull.
